(19) United States
(12) Patent Application Publication
(10) Pub. No.: US 2004/0023071 A1
(43) Pub. Date: Feb. 5, 2004

(54) Perpendicular magnetic recording medium and the method of manufacturing the same

(76) Inventors: Yasushi Sakai, Nagano (JP); Sadayuki Watanabe, Nagano (JP)

Correspondence Address: ROSSI & ASSOCIATES, P.O. Box 826, Ashburn, VA, 20146-0826, US

(21) Appl. No.: 10/418,180

(22) Filed: Apr. 17, 2003

(30) Foreign Application Priority Data
Apr. 17, 2002 (JP) 2002-115204

(51) Int. Cl. G11B 5/66

(52) U.S. Cl. 428/694 BS; 428/694 TP; 428/694 R

(57) ABSTRACT

A perpendicular magnetic recording medium includes at least a nonmagnetic substrate, an intermediate layer above the nonmagnetic substrate, a magnetic recording layer on the intermediate layer, a protective layer on the magnetic recording layer, and a liquid lubricant layer on the protective layer, and the magnetic recording layer is an amorphous alloy layer including a rare earth element and a transition metal such as a TbCo layer and a TbFeCo layer containing from 1 at. % to 15 at. % of Ag added to fix the domain walls between the recorded bits and to prevent the bits recorded at a high line recording density from shifting or erasure.

### DETAILED DESCRIPTION OF THE INVENTION

The present invention relates to a perpendicular magnetic recording medium and the method of manufacturing the perpendicular magnetic recording medium. Specifically, the present invention relates to a perpendicular magnetic recording medium mounted on various magnetic recording apparatuses and forming recording magnetization perpendicular to the recording plane thereof and to the method of manufacturing the perpendicular magnetic recording medium described above.

As the capacities of the magnetic disk storages such as the external storages of computers have become larger and larger, higher recording densities have been proposed for magnetic recording media. Conventional magnetic recording schemes mainly employ longitudinal magnetic recording that orients the recording magnetization in parallel to the recording plane of the magnetic recording medium. Recently, perpendicular magnetic recording that orients the recording magnetization in perpendicular to the recording plane of the magnetic recording medium has been attracting much attention due to the potential of realizing a higher recording density.

The recording medium according to the perpendicular magnetic recording scheme (hereinafter referred to as the “perpendicular magnetic recording medium”) includes a magnetic recording layer of a hard magnetic material and a under layer of a soft magnetic material for converging the magnetic flux generated from a magnetic head employed to record signals in the magnetic recording layer. CoCr alloy crystal films are used mainly for the material of the magnetic recording layer for the perpendicular magnetic recording medium.

Amorphous alloy film including a rare earth element and a transition metal and used for the magneto optical recording material is potential material for us as the magnetic recording layer in the perpendicular magnetic recording medium due to its large perpendicular magnetic anisotropy constant Ku. Hereinafter, the amorphous alloy film including a rare earth element and a transition metal will be referred to as the “rare-earth-transition-metal amorphous film” or simply as “the amorphous alloy film”. The amorphous alloy film having a composition near the compensation point is used for the magneto optical recording. However, it is difficult to use the amorphous alloy film in perpendicular magnetic recording without modification, since the coercive force Hc of the amorphous alloy film in the composition range around the compensation point is much higher than the coercive force, which the perpendicular magnetic recording materials are required to exhibit.

Recently, noise reduction in the perpendicular magnetic recording media, which mainly use the CoCr alloy crystal for the magnetic recording material thereof, has being explored to realize a higher recording density. The noises of the magnetic recording media are reduced by thinning the magnetic recording layer, by minimizing the diameter of the CoCr crystal grains, or by promoting segregation of a nonmagnetic element to the grain boundary. However, these methods cause a so-called thermal fluctuation that impairs the thermal stability of the recorded signals and, sometimes, erases the recorded signals.

Japanese Unexamined Laid Open Patent Application (Koukai) No. H07-discloses that a perpendicular magnetic recording medium exhibiting excellent magnetic characteristics is obtained by providing the medium with an R—Fe—B layer exhibiting a high coercive force, wherein R represents Nd, Pr or Nd and Pr. However, there exists a certain limitation in realizing a high recording density in the magnetic recording media including a magnetic recording layer having a grain boundary therein. In practice, the magnetic recording media including a magnetic recording layer having a grain boundary therein cannot perform read/write operations at a low recording density.

In contrast to the CoCr crystal film that has a grain boundary, the rare-earth-transition-metal amorphous film has no crystal grain boundary. The signals written in the amorphous alloy film are shifted or erased, since the amorphous alloy film does not have nuclei for holding the signals written therein at the initial sites. Shift or erasure of the written signals are liable to happen especially when the signals are written at a high frequency. As far as the rare-earth-transition-metal amorphous film is not improved nor modified, the amorphous alloy film is unemployable for the perpendicular magnetic recording aiming at a higher recording density.

Therefore, it would be desirable to provide a perpendicular magnetic recording medium that causes neither shift nor erasure of the written signals. It would be also desirable to provide the method of manufacturing the perpendicular magnetic recording medium with excellent productivity.

### SUMMARY OF THE INVENTION

As a result of the extensive and intensive investigations, the present inventors have found that the domain walls are fixed and excellent magnetic characteristics for a perpendicular magnetic recording medium are obtained by segregating Ag in the rare-earth-transition-metal amorphous film.

According to a preferred embodiment of the invention, a perpendicular magnetic recording medium includes: a nonmagnetic substrate, an intermediate layer above the nonmagnetic substrate, a magnetic recording layer on the intermediate layer, a protective layer on the magnetic recording layer, and a liquid lubricant layer on the protective layer, wherein the magnetic recording layer is an amorphous alloy layer including a rare earth element and a transition metal and Ag added to the amorphous alloy layer. Preferably, the concentration of the Ag added to the amorphous alloy layer is between 1 at. % and 15 at. %.

In a further embodiment the perpendicular magnetic recording medium further includes a soft magnetic under layer between the nonmagnetic substrate and the intermediate layer.

In a still further embodiment, the perpendicular magnetic recording medium further includes one or more undercoating layers between the nonmagnetic substrate and the soft magnetic under layer and a domain controlling layer between the one or more undercoating layers and the soft magnetic under layer, and the domain controlling layer controls the domains of the soft magnetic under layer.

There is also described a method of manufacturing a perpendicular magnetic recording medium, including the steps of: forming an intermediate layer above a nonmagnetic substrate, forming a magnetic recording layer on the intermediate layer, the magnetic recording layer being an amorphous alloy layer including a rare earth element and a transition metal and Ag added to the amorphous alloy layer, forming a protective layer on the magnetic recording layer, and forming a liquid lubricant layer on the protective layer. It is preferably that the magnetic recording layer is formed under a gas pressure between 10 mTorr and 100 mTorr.

### BRIEF DESCRIPTION OF THE DRAWINGS

The invention will be described with reference to certain preferred embodiments thereof along with the accompanying drawings, wherein:

FIG. 1 is a schematic cross sectional view of a perpendicular magnetic recording medium according to a first embodiment of the invention;

FIG. 2 is a schematic cross sectional view of a perpendicular magnetic recording medium according to a second embodiment of the invention;

FIG. 3 is a schematic cross sectional view of a perpendicular magnetic recording medium according to a third embodiment of the invention;

FIG. 4 is a pair of curves relating the magnetic characteristics with the doping amount of Ag for each perpendicular magnetic recording medium according to the first embodiment of the invention;

FIG. 5 is a curve relating the perpendicular magnetic anisotropy constant with the doping amount of Ag for each perpendicular magnetic recording medium according to the first embodiment of the invention;

FIG. 6 is a pair of curves relating the coercive force and the squareness ratio with the gas pressure, under which the magnetic recording layer of each perpendicular magnetic recording medium according to the first embodiment is formed;

FIG. 7 is a curve relating the perpendicular magnetic anisotropy constant with the gas pressure, under which the magnetic recording layer of each perpendicular magnetic recording medium according to the first embodiment is formed;

FIG. 8 is a curve relating the SNR with the doping amount of Ag in the perpendicular magnetic recording medium according to the second embodiment;

FIG. 9 is a curve relating the SNR with the gas pressure, under which the magnetic recording layer of each perpendicular magnetic recording medium according to the second embodiment is formed; and

FIG. 10 is a pair of output waveforms obtained with a spin stand tester for one turn of the perpendicular magnetic recording media.

### DETAILED DESCRIPTION OF THE PREFERRED EMBODIMENTS

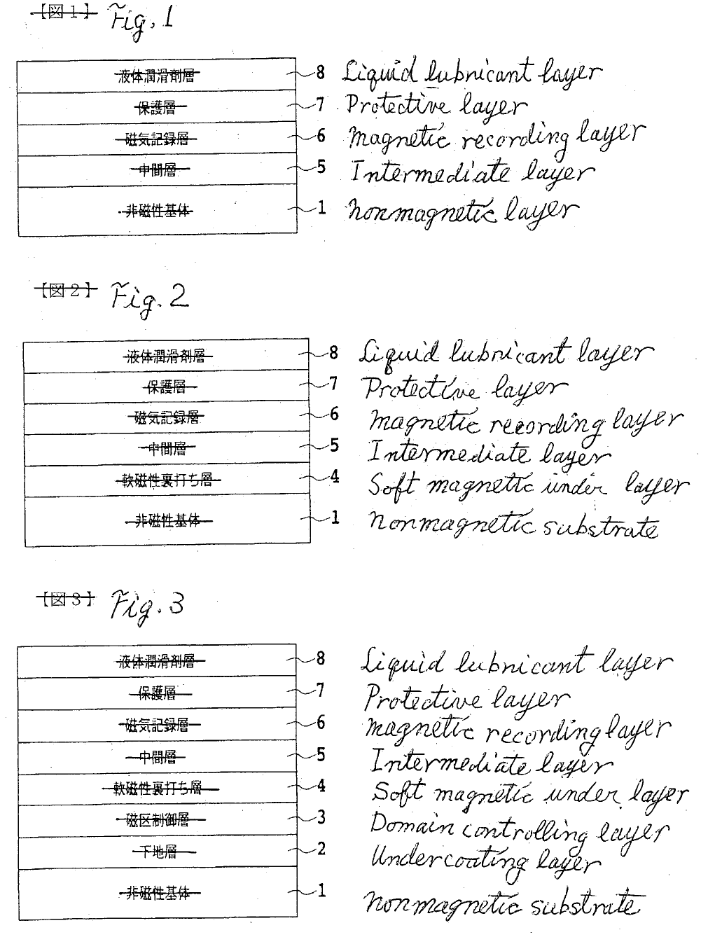

FIG. 1 is a schematic cross sectional view of a perpendicular magnetic recording medium according to a first embodiment of the invention. Referring to FIG. 1, the perpendicular magnetic recording medium according to the first mode includes at least an intermediate layer 5 above a nonmagnetic substrate 1, a magnetic recording layer 6 on the intermediate layer 5, a protective layer 7 on the magnetic recording layer 6, and a liquid lubricant layer 8 on the protective layer 7. The nonmagnetic substrate 1 is a circular carrier plate, on which the magnetic films are deposited. Al alloys, chemical strengthened glass, and crystallized glass provided with NiP plating and used for the conventional magnetic recording media are used for the nonmagnetic substrate 1. The intermediate layer 5 is used to control the characteristics of the magnetic recording layer 6. Nonmagnetic elements and nonmagnetic alloys are used appropriately for the intermediate layer 5. Preferably, the intermediate layer 5 is between 5 nm and 30 nm in thickness. The magnetic recording layer 6 is a rare-earth-transition-metal amorphous film. For example, TbCo, TbFeCo and such amorphous alloys are preferably used for the magnetic recording layer 6. A conventional protective film, such as a film containing carbon as its main component, is utilized for the protective layer 7. The protective layer 7 is formed under the conditions for forming the protective films of the conventional magnetic recording media. Conventional materials are used for the liquid lubricant layer 8. For example, perfluoropolyether lubricants are preferably used. The parameters such as the thickness of the liquid lubricant layer 8 are set at the parameters for the conventional magnetic recording media.

It is a feature of the present invention that Ag is contained in the rare-earth-transition-metal amorphous film. The added Ag facilitates fixing the domain walls between the recorded bits at the locations, thereat the domain walls were when signals were written into the pertinent bits. Therefore, the bits recorded at a high recording density by domain wall motion are prevented from shifting and erasure.

Ag is added to the rare-earth-transition-metal amorphous film by depositing Ag from a target containing Ag and an amorphous alloy including a rare earth element and a transition metal or by depositing Ag from a Ag chip positioned on an amorphous alloy target. When the amorphous alloy film contains less than 1 at. % of Ag, the doping amount of Ag is too small to sufficiently fix the domain walls. The amorphous alloy film containing more than 15 at. % of Ag does not work as a perpendicular magnetic recording layer, since a sufficient perpendicular magnetic anisotropy is not obtained. Therefore, the Ag concentration is preferably between 1 at. % and 15 at. % to obtain satisfactory characteristics for a perpendicular magnetic recording medium.

When the gas pressure, under which the magnetic recording layer 6 is formed, is lower than 10 mTorr, it is difficult to write signals, since the magnetic exchange interaction is too strong. When the gas pressure is higher than 100 mTorr, the magnetic recording layer formed is not suitable for perpendicular recording due to low perpendicular magnetic anisotropy. Therefore, it is desirable to set the gas pressure for forming the magnetic recording layer 6 between 10 mTorr and 100 mTorr.

A perpendicular magnetic recording medium according to a second embodiment of the invention further includes, between the nonmagnetic substrate and the intermediate layer, a soft magnetic under layer for converging the magnetic flux generated by a magnetic head used for recording in a magnetic recording layer. FIG. 2 is a schematic cross sectional view of a perpendicular magnetic recording medium according to the second embodiment of the invention.

Referring now to FIG. 2, the perpendicular magnetic recording medium according to the second embodiment includes at least a soft magnetic under layer 4 above a nonmagnetic substrate 1, an intermediate layer 5 on the soft magnetic under layer 4, a magnetic recording layer 6 on the intermediate layer 5, a protective layer 7 on the magnetic recording layer 6, and a liquid lubricant layer 8 on the protective layer 7. The substrate 1, the intermediate layer 5, the magnetic recording layer 6, the protective layer 7, and the liquid lubricant layer 8 are configured in the same manner as those in the perpendicular magnetic recording medium according to the first mode. The soft magnetic under layer 4 is disposed to converge the magnetic flux generated by the magnetic head used for recording in the magnetic recording layer 6. NiFe alloys, Sendust (FeSiAl) alloys and such alloys are used for the soft magnetic under layer 4. For example, excellent electromagnetic conversion characteristics are obtained by using an amorphous Co alloy such as CoNbZr and CoTaZr. Although it depends on the structure and the characteristics of the recording magnetic head, the soft magnetic under layer 4 is preferably from 10 nm to 300 nm in thickness considering the productivity thereof. The intermediate layer 5 controls the characteristics of the magnetic recording layer 6 and magnetically isolates the soft magnetic under layer 4 and the magnetic recording layer 6 from each other.

A perpendicular magnetic recording medium according to a third embodiment of the invention includes, between the nonmagnetic substrate and the soft magnetic under layer, one or more undercoating layers and an antiferromagnetic layer (hereinafter referred to as a “domain controlling layer”) for controlling the domains in the soft magnetic under layer. FIG. 3 is a schematic cross sectional view of a perpendicular magnetic recording medium according to the third embodiment.

Referring now to FIG. 3, the perpendicular magnetic recording medium according to the third mode includes at least an undercoating layer 2 on a nonmagnetic substrate 1, a domain controlling layer 3 on the undercoating layer 2, a soft magnetic under layer 4 on the domain controlling layer 3, an intermediate layer 5 on the soft magnetic under layer 4, a magnetic recording layer 6 on the intermediate layer 5, a protective layer 7 on the magnetic recording layer 6, and a liquid lubricant layer 8 on the protective layer 7. The substrate 1, the soft magnetic under layer 4, the intermediate layer 5, the magnetic recording layer 6, the protective layer 7, and the liquid lubricant layer 8 are configured in the same manner as those in the perpendicular magnetic recording medium according to the second mode. An antiferromagnetic film formed of an alloy containing Mn or a hard magnetic film, the magnetization thereof is oriented in the radial direction of the circular plate of the nonmagnetic substrate 1, is used for the domain controlling layer 3. The domain controlling layer 3 is preferably from 5 nm to 300 nm in thickness. The undercoating layer 2 includes at least an orientation controlling layer for controlling the orientation of the magnetization in the domain controlling layer 3. When a Mn alloy antiferromagnetic film is used for the domain controlling layer 3, it is preferable for the undercoating layer 2 to be made of a nonmagnetic metal having a face center cubic structure or a nonmagnetic alloy. In this case, the undercoating layer 2 may further include, on the side of the nonmagnetic substrate 1, a lower layer for controlling the fine structure of the nonmagnetic metal layer or the nonmagnetic alloy layer described above. When a hard magnetic film is used for the domain controlling layer 3, Cr alloys are employable for the undercoating layer 2. In this case, the undercoating layer 2 may further include, on the side of the nonmagnetic substrate 1, a plurality of lower layers for controlling the fine structure of the Cr alloy layer.

Now specific examples of manufacturing a recording medium will be described in connection with the preferred embodiments of the invention. Although the invention will be described below in connection with the preferred embodiments thereof, changes and modifications are obvious to those skilled in the art without departing from the true spirit of the invention.

### FIRST EXAMPLE

A smooth and flat chemical strengthened glass substrate (Glass substrate N-5 supplied from Hoya Corp.) is used for the nonmagnetic substrate 1. After being cleaned, the glass substrate is loaded in a vacuum chamber of a sputtering apparatus and a Ti layer is deposited on the glass substrate, resulting in a Ti intermediate layer 5. The resulting Ti intermediate layer 5 is 15 nm in thickness. Then, a magnetic recording layer 6 is formed on the Ti intermediate layer 5 using a composite target consisting of a TbCo target and a Ag chip placed on the TbCo target. The doping amount of Ag is adjusted by changing the number of the Ag chips on the TbCo target. The gas pressure inside the vacuum chamber is controlled between 5 mTorr and 150 mTorr by adjusting the total flow rate of the gas used for film deposition and the opening of the valve disposed between the vacuum chamber and the vacuum pump. The thickness of the magnetic recording layer 6 is set at 30 nm. A carbon protective layer 7 of 5 nm in thickness is then formed on the magnetic recording layer 6. Then, the laminate formed so far is taken out from the vacuum chamber. The constituent layers except the magnetic recording layer 6 are formed by DC magnetron sputtering under the gas pressure of 5 mTorr. Finally, a perfluoropolyether liquid lubricant layer 8 of 2 nm in thickness is formed on the carbon protective layer by dip-coating. Thus, the perpendicular magnetic recording media according to the first embodiment is fabricated.

The magnetic characteristics of the perpendicular magnetic recording media fabricated are calculated from the magnetization curves measured with a vibrating sample magnetometer. The perpendicular magnetic anisotropy constants Ku are calculated from the magnetic torque curves measured in a plane containing the normal to the substrate surface.

FIG. 4 is a pair of curves relating the coercive force He and the squareness ratio S with the doping amount of Ag for each perpendicular magnetic recording medium according to the first embodiment of the invention. The coercive force He rises sharply by adding 1 at. % or more of Ag to the rare-earth-transition-metal amorphous film and reaches a high value of more than 5000 Oe at the Ag doping amount of around 5 at. %. The coercive force He lowers monotonically with further addition of Ag and reaches a low value of less than 3000 Oe at the Ag doping amount of 20 at. % or more. The squareness ratio S is at an excellent value of almost 1 up to the Ag doping amount of 15%. However, the squareness ratio S lowers sharply with further increase of the Ag doping amount.

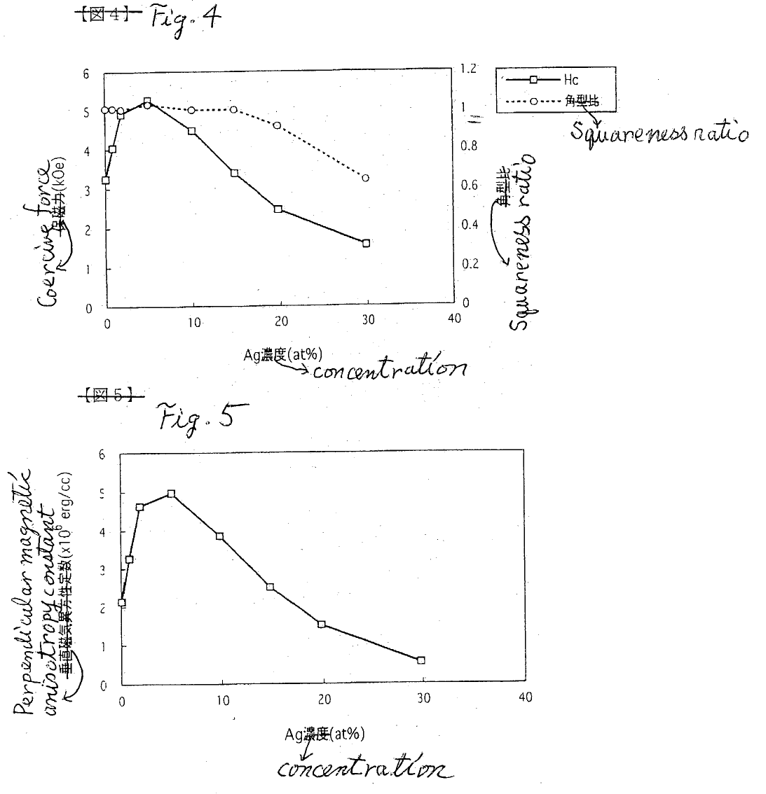

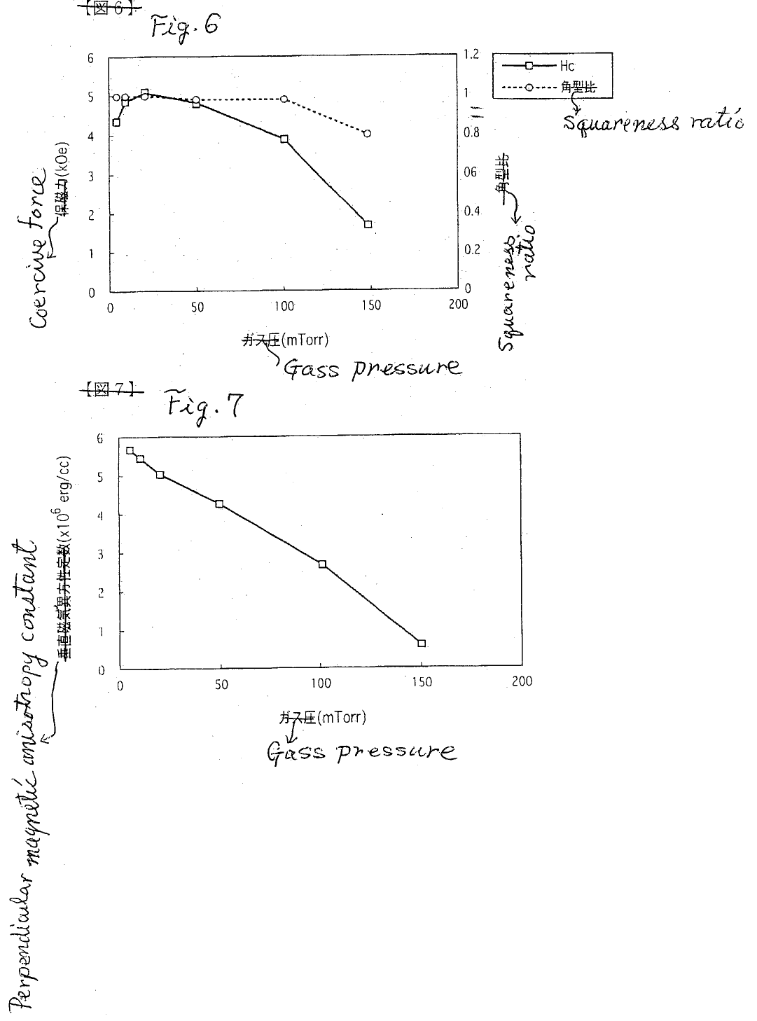

FIG. 5 is a curve relating the perpendicular magnetic anisotropy constant Ku with the doping amount of Ag for each perpendicular magnetic recording medium according to the first embodiment. The perpendicular magnetic anisotropy constant Ku is around 2×10⁶ erg/cc when no Ag is added. The perpendicular magnetic anisotropy constant Ku rises sharply with increasing Ag doping amount and takes a relatively large value of 5×10⁶ erg/cc at the Ag doping amount of 5 at. %, at which the coercive force He takes the maximum value. The perpendicular magnetic anisotropy constant Ku lowers monotonically with further increase of the Ag doping amount and is, at the Ag doping amount of 20 at. %, 1.5×10⁶ erg/cc or lower, too low to be the perpendicular magnetic anisotropy constant for the perpendicular magnetic recording medium. Obviously, the change of the coercive force He with the Ag doping amount described in FIG. 4 is affected by the change of the perpendicular magnetic anisotropy constant Ku.

As described above, excellent magnetic characteristics are obtained by adding less than 15 at. % of Ag to the rare-earth-transition-metal amorphous film.

FIG. 6 is a pair of curves relating the coercive force Hc and the squareness ratio S with the gas pressure for each perpendicular magnetic recording medium according to the first embodiment. A high coercive force of 3000 Oe or higher is obtained in the gas pressure range of 100 mtorr or lower. The squareness ratio S is at an excellent value of almost 1 also in the gas pressure range of 100 mTorr or lower.

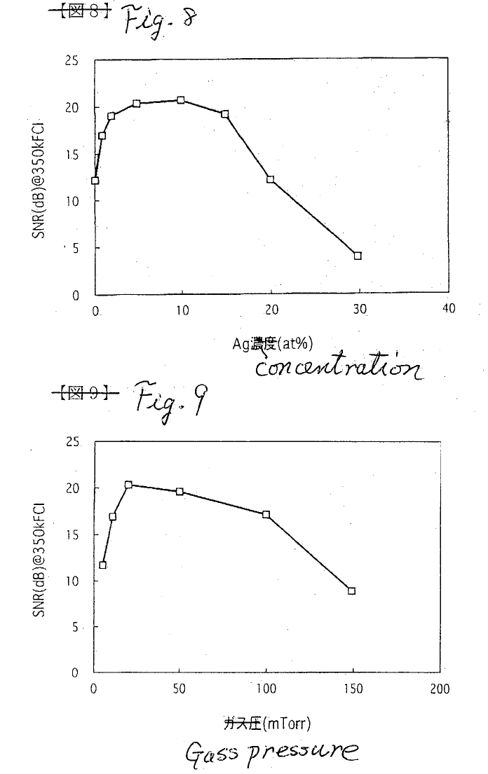

FIG. 7 is a curve relating the perpendicular magnetic anisotropy constant Ku with the gas pressure, under which the magnetic recording layer of each perpendicular magnetic recording medium according to the first embodiment is formed. Although the perpendicular magnetic anisotropy constant Ku takes a high value of 5.7×10⁶ erg/cc at the gass pressure of 5 mTorr, the perpendicular magnetic anisotropy constant Ku lowers monotonically with increasing gas pressure and is 2,7×10⁶ erg/cc at the gas pressure of 100 mTorr. The perpendicular magnetic anisotropy constant Ku takes a low value of 1×10⁶ erg/cc at the gas pressure of 150 mTorr.

### SECOND EXAMPLE

A nonmagnetic substrate same with the nonmagnetic substrate used in the perpendicular magnetic recording media according the first embodiment is used according to the second embodiment of the invention. The nonmagnetic substrate 1 is cleaned and loaded in the vacuum chamber of the sputtering apparatus. First, a soft magnetic under layer 4 is formed using a CoZrNb target. The formed soft magnetic under layer 4 is 200 nm in thickness. Then, an intermediate layer 5, a magnetic recording layer 6, a protective layer 7, and a liquid lubricant layer 8 are formed in the same manner as those in the perpendicular magnetic recording media according the first embodiment. Thus, perpendicular magnetic recording media having the configuration as illustrated in FIG. 2 is fabricated. The electromagnetic conversion characteristics of the perpendicular magnetic recording media according the second embodiment are measured with a spin stand tester using a GMR head.

FIG. 8 is a curve relating the SNR (the ration of the noises to the signals in the electromagnetic conversion) at the linear recording density of 350 kFCI with the doping amount of Ag. When Ag is not added, the SNR takes a low value of around 12 dB. The low SNR is caused, since there is no nucleus for making the written signals stay in the sites, wherein the signals have been written initially and, therefore, the written signals shift the positions thereof. Nuclei are formed by adding 1 at. % or more Ag and a high SNR of 15 dB or higher is obtained. However, the SNR lowers sharply as the Ag doping amount exceeds 15 at. % to the higher side. This is because the perpendicular magnetic anisotropy lowers when the Ag doping amount is too high. Therefore, it is preferable to confine the Ag doping amount in the range between 1 at. % and 15 at. %.

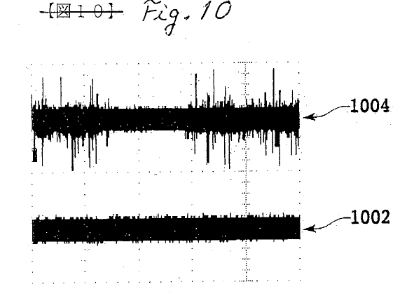

FIG. 9 is a curve relating the SNR at the linear recording density of 350 kFCI with the gas pressure, under which the magnetic recording layer of each perpendicular magnetic recording medium according to the second embodiment is formed. A high SNR of 15 dB or higher is obtained in the gas pressure range between 10 mTorr and 100 mTorr. When the gas pressure is lower than 10 mTorr, write signals can not be written in especially at a high recording density due to too strong exchange interaction inside the magnetic recording layer or the SNR is impaired due to the shifts of the written signals. When the gas pressure is higher than 100 mTorr, the perpendicular magnetic anisotropy is lowered and, therefore, the SNR is impaired.

Summarizing the results described above, it is preferable to set the doping amount of Ag to the rare-earth-transition metal amorphous alloy film between 1 at. % and 15 at. % and the gas pressure, under which the amorphous alloy film is formed, between 10 mTorr and 100 mtorr.

### THIRD EXAMPLE

A nonmagnetic substrate same with the nonmagnetic substrate used in the perpendicular magnetic recording media according the second embodiment is used according to the third embodiment of the invention. The nonmagnetic substrate 1 is cleaned and loaded in the vacuum chamber of the sputtering apparatus. First, a Ta layer is formed on the nonmagnetic substrate 1, resulting in a first undercoating layer. The resulting first undercoating layer is 5 nm in thickness. Then, a NiFeCr layer is formed on the first undercoating layer resulting in a second undercoating layer. The resulting second undercoating layer is 5 nm in thickness. Then, an IrMn layer is formed on the second undercoating layer, resulting in a domain controlling layer 3. The resulting domain controlling layer 3 is 10 nm in thickness. Then, a soft magnetic under layer 4, an intermediate layer 5, a magnetic recording layer 6, a protective layer 7, and a liquid lubricant layer 8 are formed in the same manner as those in the perpendicular magnetic recording media according the second embodiment. Thus, perpendicular magnetic recording media having the configuration as illustrated in FIG. 3 are fabricated.

FIG. 10 is a pair of output waveforms obtained with a spin stand tester for one turn of the perpendicular magnetic recording medium according to the third embodiment and a comparative perpendicular magnetic recording medium. Among the waveforms in FIG. 10, the waveform 1002 is an output waveform for one turn of the perpendicular magnetic recording medium according to the third embodiment. The waveform 1004 is an output waveform for one turn of a comparative perpendicular magnetic recording medium having a configuration similar to that in the perpendicular magnetic recording medium according to the second embodiment provided with neither undercoating layer nor domain controlling layer. When the perpendicular magnetic recording medium includes neither undercoating layer nor domain controlling layer, spike noises are caused over the full turn thereof. In contrast, provision of one or more undercoating layers and a domain controlling layer prevents spike noises from causing, since no domain wall is formed in the soft magnetic under layer due to the provision of the one or more undercoating layers and the domain controlling layer.

As described above, the perpendicular magnetic recording medium according to the invention includes at least a nonmagnetic substrate, an intermediate layer above the nonmagnetic substrate, a magnetic recording layer on the intermediate layer, a protective layer on the magnetic recording layer, and a liquid lubricant layer on the protective layer, wherein the magnetic recording layer is a rare-earth-transition-metal amorphous alloy layer, to which Ag is added. By adding from 1 at. % to 15 at. % of Ag, a perpendicular magnetic recording medium exhibiting excellent characteristics is obtained.

The soft magnetic under layer disposed between the nonmagnetic substrate and the intermediate layer facilitates converging the magnetic flux generated from a magnetic head and forming a sharp magnetic field gradient across the magnetic recording layer. The provision of the soft magnetic under layer further improves the characteristics of the perpendicular magnetic recording medium.

One or more undercoating layers and a domain controlling layer disposed between the nonmagnetic substrate and the soft magnetic under layer completely prevent spike noises caused by domain walls formed in the soft magnetic under layer from occurring and facilitate providing a practical perpendicular magnetic recording medium.

By forming the magnetic recording layer under a gas pressure between 10 mTorr and 100 mTorr, a practical perpendicular magnetic recording medium exhibiting excellent characteristics is obtained.

Since the magnetic recording medium according to the invention may be manufactured using the conventional manufacturing facilities, the method of manufacturing the magnetic recording medium according to the invention is suitable for mass production.

The invention has been described with reference to certain preferred embodiments thereof. It will be understood, however, that modifications and variations are possible within the scope of the appended claims.

What is claimed is:

1. A perpendicular magnetic recording medium comprising:
a nonmagnetic substrate;
an intermediate layer above the nonmagnetic substrate;
a magnetic recording layer on the intermediate layer;
a protective layer on the magnetic recording layer; and
a liquid lubricant layer on the protective layer;
wherein the magnetic recording layer comprises an amorphous alloy layer comprising a rare earth element, a transition metal and Ag.

2. The perpendicular magnetic recording medium according to claim 1, wherein the concentration of the Ag in the amorphous alloy layer is between 1 at. % and 15 at. %.

3. The perpendicular magnetic recording medium according to claim 1, further comprising a soft magnetic under layer between the nonmagnetic substrate and the intermediate layer.

4. The perpendicular magnetic recording medium according to claim 2, further comprising a soft magnetic under layer between the nonmagnetic substrate and the intermediate layer.

5. The perpendicular magnetic recording medium according to claim 3, further comprising one or more undercoating layers between the nonmagnetic substrate and the soft magnetic under layer and a domain controlling layer between the one or more undercoating layers and the soft magnetic under layer, the domain controlling layer controlling the domains of the soft magnetic under layer.

6. The perpendicular magnetic recording medium according to claim 4, further comprising one or more undercoating layers between the nonmagnetic substrate and the soft magnetic under layer and a domain controlling layer between the one or more undercoating layers and the soft magnetic under layer, the domain controlling layer controlling the domains of the soft magnetic under layer.

7. A method of manufacturing a perpendicular magnetic recording medium comprising:
forming an intermediate layer above a nonmagnetic substrate,
forming a magnetic recording layer on the intermediate layer, the magnetic recording layer comprising an amorphous alloy layer comprising a rare earth element, a transition metal and Ag,
forming a protective layer on the magnetic recording layer, and
forming a liquid lubricant layer on the protective layer.

8. The method according to claim 7, wherein the step of forming the magnetic recording layer is conducted under a gas pressure between 10 mTorr and 100 mTorr.

9. The method to claim 7, wherein the concentration of the Ag in the amorphous alloy layer is between 1 at. % and 15 at. %.

10. The method according to claim 7, further comprising forming a soft magnetic under layer between the nonmagnetic substrate and the intermediate layer.

11. The method according to claim 9, further comprising forming a soft magnetic under layer between the nonmagnetic substrate and the intermediate layer.

12. The method according to claim 10, further comprising forming one or more undercoating layers between the nonmagnetic substrate and the soft magnetic under layer and forming a domain controlling layer between the one or more undercoating layers and the soft magnetic under layer, the domain controlling layer controlling the domains of the soft magnetic under layer.

13. The method according to claim 11, further comprising forming one or more undercoating layers between the nonmagnetic substrate and the soft magnetic under layer and forming a domain controlling layer between the one or more undercoating layers and the soft magnetic under layer, the domain controlling layer controlling the domains of the soft magnetic under layer.
